(19) United States
(12) Patent Application Publication
(10) Pub. No.: US 2021/0339423 A1
(43) Pub. Date: Nov. 4, 2021

(54) STAPLER, IMAGE FORMING DEVICE, AND POST-PROCESSING DEVICE

(71) Applicant: MAX CO., LTD., Tokyo (JP)

(72) Inventors: Yoshio CHIGIRA, Tokyo (JP); Toshiyuki TAKAHASHI, Tokyo (JP)

(73) Assignee: MAX CO., LTD., Tokyo (JP)

(21) Appl. No.: 17/243,772

(22) Filed: Apr. 29, 2021

(30) Foreign Application Priority Data
Apr. 30, 2020 (JP) 2020-080672

(51) Int. Cl. B27F 7/38; B27F 7/36

(52) U.S. Cl. CPC B27F 7/38; B27F 7/36

(57) ABSTRACT

An electric stapler includes a clamp part that clamps a paper bundle, a penetration part that causes a staple to penetrate the paper bundle, a clinch part that bends the staple penetrating the paper bundle to bind the paper bundle, a driving unit that drives the clamp part, the penetration part, and the clinch part. The electric stapler performs binding processing by at least performing a clamping process of clamping the paper bundle with the clamp part, a penetrating process of causing the staple to penetrate the paper bundle with the penetration part, and a clinching process of bending the staple penetrating the paper bundle with the clinch part. The electric stapler includes a state detection unit that detects a state of the driving unit in each of the clamping process, the penetrating process and the clinching process, and a storage unit that stores the detected state.

### CROSS-REFERENCE TO RELATED APPLICATION

This application is based upon and claims the benefit of priority from prior Japanese patent application No. 2020-080672, filed on Apr. 30, 2020, the entire contents of which are incorporated herein by reference.

### TECHNICAL FIELD

The present invention relates to a stapler, an image forming device, and a post-processing device.

### BACKGROUND ART

In the related art, there has been widely known an electric stapler that automatically binds a paper bundle with staples. Among such electric staplers, there has been proposed an electric stapler capable of determining an operation failure occurring at the time of binding processing.

For example, Patent Literature 1 discloses a sheet binding device that detects a load at the time of staple striking and determines whether a staple is normally struck into paper. Patent Literature 2 discloses a paper binding device that determines a state of a stapler based on a signal from a home sensor.

### CITATION LIST

### Patent Literature

Patent Literature 1: JP-A-H01-146673

Patent Literature 2: JP-A-H04-348995

### SUMMARY OF INVENTION

### Technical Problem

However, the stapler disclosed in Patent Literature 1 cannot determine an operation failure other than one at the time of staple striking. In addition, since the stapler disclosed in Patent Literature 2 determines an abnormality of the stapler based on the signal from the home sensor, it is not possible to determine in which process of a series of binding processing processes (for example, a clamping process of gripping a paper bundle, a penetrating process of causing a staple to penetrate the paper bundle, and a clinching process of bending legs of the staple penetrating the paper bundle) the abnormality occurs and what kind of abnormality occurs. For this reason, there is a problem that, when an attempt is made to investigate the cause of malfunction of the stapler, a large amount of time is required until the details of the cause of the malfunction are identified.

Therefore, the present invention has been made in view of the above problems, and an object thereof is to provide a stapler, an image forming device, and a post-processing device capable of determining a state of the stapler including a cause of malfunction (abnormality) of the stapler for each process.

### Solution to Problem

An electric stapler according to the present disclosure including a clamp part that clamps a paper bundle, a penetration part that causes a staple to penetrate the paper bundle, a clinch part that bends the staple penetrating the paper bundle to bind the paper bundle, a driving unit that drives the clamp part, the penetration part, and the clinch part, and performing binding processing by at least performing a clamping process of clamping the paper bundle with the clamp part, a penetrating process of causing the staple to penetrate the paper bundle with the penetration part, and a clinching process of bending the staple penetrating the paper bundle with the clinch part, includes: a state detection unit that detects a state of the driving unit in each of the clamping process, the penetrating process and the clinching process; and a storage unit that stores the detected state.

### Advantageous Effects

According to the present disclosure, since the state of the driving unit can be detected for each process, it is possible to determine in which process, for example, an operation failure occurs. In addition, since the state of the driving unit for each process is stored in the storage unit, it is possible to easily perform an investigation based on information stored in the storage unit when the cause of the malfunction of the stapler is to be investigated later.

### BRIEF DESCRIPTION OF DRAWINGS

FIG. 1 is a schematic diagram of an image forming system according to an embodiment.

FIG. 2 is a side view of a stapler according to the present embodiment.

FIG. 3 is a perspective view of the stapler according to the present embodiment.

FIG. 4 is a block diagram illustrating a hardware configuration of a post-processing device according to the present embodiment.

FIG. 5 is a flowchart illustrating a flow of processing related to acquisition and storage of a current value to a motor in each process.

FIG. 6 is a flowchart illustrating a flow of processing related to measurement of operation time of each process and storage of the measured operation time.

FIG. 7 is a flowchart illustrating a flow of processing of calculating and storing a difference (deviation) between target electric power or current value of a motor and actually detected electric power or current value in each process.

FIG. 8 is a flowchart in a case where abnormality diagnosis of a penetrating process is executed based on a current value stored in a storage unit.

### DESCRIPTION OF EMBODIMENTS

Hereinafter, preferred embodiments of the present invention will be described in detail with reference to the accompanying drawings.

<Configuration Example of Image Forming System 100>

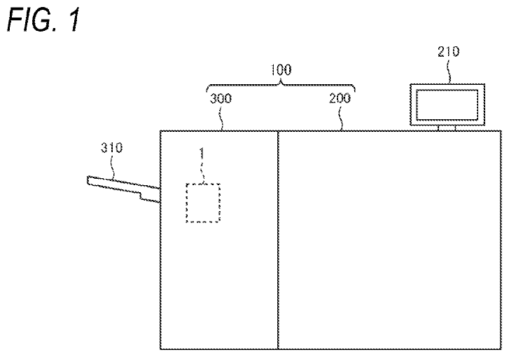

FIG. 1 is a configuration diagram illustrating an overview of an image forming system 100 according to the present embodiment.

As illustrated in FIG. 1, the image forming system 100 includes an image forming device 200 that forms a predetermined image on a sheet of paper, and a post-processing device 300 that can perform at least one type of post-processing (for example, binding processing of a paper bundle) on the sheet of paper.

The image forming device 200 forms a predetermined image on a sheet of paper supplied from a paper feeding portion (not illustrated) inside or outside the device, and conveys the sheet of paper to the post-processing device 300. For example, the image forming device 200 forms an image on a sheet of paper by forming an electrostatic latent image by scanning exposure, developing the electrostatic latent image with toner, transferring the toner to the sheet of paper, and fixing the toner. An operation panel 210 for inputting conditions and the like related to printing and post-processing is provided on an upper surface portion of the image forming device 200.

The post-processing device 300 is connected to a downstream side of the image forming device 200 in a paper conveying direction, and includes an electric stapler 1 that performs binding processing of binding a paper bundle with staples. Details of the electric stapler 1 will be described later. A tray 310 on which paper is placed is provided on a side surface of the post-processing device 300 opposite to the image forming device 200.

<Configuration Example of Electric Stapler 1>

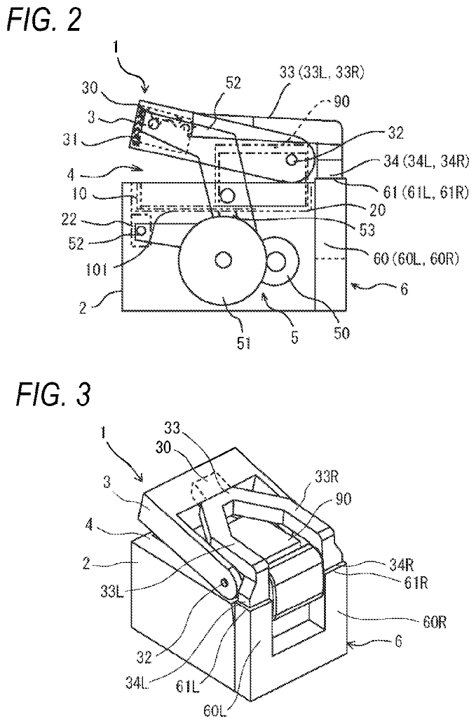

FIG. 2 is a side view of the electric stapler 1 according to the present embodiment, and FIG. 3 is a perspective view of the electric stapler 1 according to the present embodiment.

The electric stapler 1 includes a staple striking unit 2 that supplies and strikes a staple 10, and a binding unit 3 that cuts a pair of legs of the staple 10 in cooperation with the staple striking unit 2 and bends the cut legs inward to bind a paper bundle with the staple 10.

The staple striking unit 2 includes a stapler body 20 to which a staple cartridge 90 in which the staple 10 is accommodated is detachably attached, and a penetration part 22 that strikes the staple 10 sent out from the staple cartridge 90 into a paper bundle and causes the staple 10 to penetrate the paper bundle. The penetration part 3 may include a movable part movable between a first position and a second position. The second position is apart from the first position in the direction orthogonal to a surface of the paper bundle.

The staple 10 is provided as a staple sheet 101 in which, for example, a plurality of linear staples 10 are connected in a sheet form by adhesion. A plurality of staple sheets 101 are accommodated in the staple cartridge 90 in a stacked state. The staple sheets 101 stored in the staple cartridge 90 are conveyed one by one in a predetermined conveying direction, and the staple 10 at a leading end (in the conveying direction) of the conveyed staple sheet 101 is struck by the penetration part 22. Then, at this time, the second or third staple 10 is formed into a substantially U-shape in advance before being struck. In addition to being accommodated directly in the staple cartridge 90, the staple sheet 101 may be accommodated via an accommodation box called refill that is detachable from the staple cartridge 90. The clinch part 4 may include a contact surface which comes into contact with the staple 10 to bend the staple 10.

The binding unit 3 includes a cutting part 30 that cuts the legs of the staple 10 penetrating the paper bundle to a predetermined length, and a clinch part 31 that binds the paper bundle by bending the legs of the staple 10 penetrating the paper bundle and cut to the predetermined length toward paper bundle. The clinch part 31 is provided at a position facing the penetration part 22, and the cutting part 30 is disposed at a position close to the clinch part 31. The cutting part 30 is not necessarily an essential component for the electric stapler 1, and the legs may be bent without being cut.

The electric stapler 1 includes a clamp part 4 that clamps (grips) a paper bundle between the staple striking unit 2 and the binding unit 3. The clamp part 4 is provided on one side of the electric stapler 1 in which the penetration part 22 of the staple striking unit 2 and the clinch part 31 of the binding unit 3 are provided.

In order to allow a binding position of the paper bundle by the staple 10 to be located between the penetration part 22 and the clinch part 31, the clamp part 4 has a shape opened in three directions, on a front surface side and both left and right side surfaces of the electric stapler 1.

The electric stapler 1 includes a driving unit 5 that drives the clamp part 4, the penetration part 22, the cutting part 30, the clinch part 31, and the like. The driving unit 5 includes a motor 50 that is provided in the staple striking unit 2, a gear 51 that is connected to a driving shaft (output shaft) of the motor 50 and driven by the motor 50, and a link part 52 that transmits operation of the gear 51 to each component such as the penetration part 22 and the clinch part 31.

The binding unit 3 operates via the link part 52 and the like by the rotation of the gear 51, and moves in directions of contacting and separating from the staple striking unit 2. In the present embodiment, the binding unit 3 moves in directions of contacting and separating from the staple striking unit 2 in a rotation operation with a shaft 32 serving as a fulcrum.

When the gear 51 is rotated in one direction from a home position (initial position), the binding unit 3 moves in a direction of approaching the staple striking unit 2, and accordingly the clamp part 4 clamps the paper bundle placed between the binding unit 3 and the staple striking unit 2 at a predetermined timing. Then, when the gear 51 is further rotated, the penetration part 22 is operated to cause the staple 10 to penetrate the clamped paper bundle. Thereafter, when the gear 51 is further rotated, the cutting part 30 and the clinch part 31 are operated in the future to cut the legs of the staple 10, and thereafter bend the cut legs toward the paper bundle. Thereafter, when the gear 51 is further rotated, the binding unit 3 moves in a direction of separating from the staple striking unit 2 to release the paper bundle from being clamped. In addition, the gear 51 is set to return to the home position again when the series of processes of binding processing is completed. As described above, while the gear 51 is rotated in one direction, a series of processes of binding processing are executed including a clamping process of clamping (gripping) the paper bundle with the clamp part 4, a penetrating process of causing the staple 10 to penetrate the paper bundle with the penetration part 22, a clinching process of binding the paper bundle by bending the staple 10 penetrating the paper bundle, and a returning process of releasing the clamping of the paper bundle by separating the binding unit 3 from the staple striking unit 2.

The electric stapler 1 includes a cut staple accommodating part 6 that accommodates a cut staple 13 cut by the cutting part 30. The cut staple accommodating part 6 is detachably attached to the electric stapler 1 on a rear side of the electric stapler 1 opposite to the side on which the clamp part 4 is provided.

The cut staple accommodating part 6 includes two collection paths 60L and 60R. The collection paths 60L and 60R are branched and disposed on both sides of the stapler body 20 so as not to block an attachment/detachment path of the staple cartridge 90 to be attached to and detached from the stapler body 20 when the cut staple accommodating part 6 is attached to the electric stapler 1.

The binding unit 3 includes a discharge path 33 through which the cut needle 13 is guided to the cut staple accommodating part 6. With respect to the discharge path 33, one discharge path 33 communicating with the cutting part 30 is branched into two discharge paths 33L and 33R arranged on both left and right sides of the stapler body 20 so as not to block the attachment/detachment path of the staple cartridge 90 to be attached to and detached from the stapler body 20.

A discharge port 34L of the one discharge path 33L communicates with a collection port 61L of the one collection path 60L of the cut staple accommodating part 6, and a discharge port 34R of the other discharge path 33R communicates with a collection port 61R of the other collection path 60R of the cut staple accommodating part 6.

Accordingly, the cut staple 13 passing through the one discharge path 33L passes through the collection path 60L from the collection port 61L and is accommodated in the cut staple accommodating part 6, and the cut staple 13 passing through the other discharge path 33R passes through the collection path 60R from the collection port 61R and is accommodated in the cut staple accommodating part 6.

<Example of Hardware Configuration of Post-Processing Device 300>

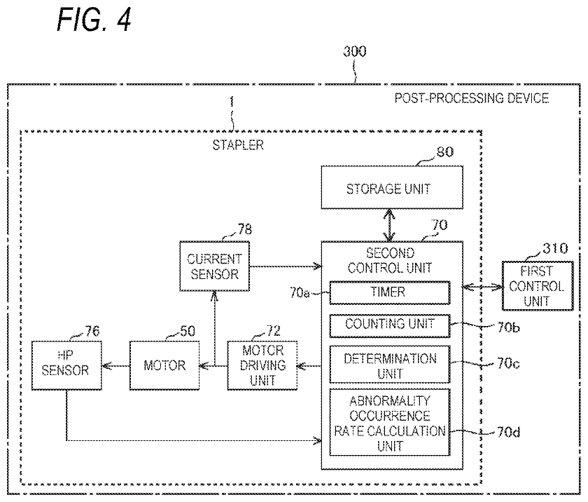

FIG. 4 is a block diagram illustrating a hardware configuration of the post-processing device 300.

As illustrated in FIG. 4, the post-processing device 300 includes: a first control unit (first controller) 310 that controls operations of the entire post-processing device 300 and includes a central processing unit (CPU); and the electric stapler 1 that performs the binding processing based on an instruction from the first control unit 310. The first control unit 310 implements predetermined post-processing by executing control in conjunction with the image forming device 200.

The electric stapler 1 includes a second control unit (second controller) 70 including a CPU, a motor driving unit (motor driving circuit) 72, the motor 50, a home position sensor (HP sensor) 76, a current sensor (state detection unit) 78 that detects a driving current of the motor 50, and a storage unit 80.

The second control unit 70 is connected to the first control unit 310, and executes control related to the binding processing in accordance with a program stored in the storage unit 80 or another storage unit. The second control unit 70 generates a motor driving signal based on a set target rotational speed of the motor 50, position information of the motor 50 from a sensor (not illustrated), and the like, and drives the motor 50.

When the binding processing is performed, the second control unit 70 acquires a current value (driving current) of the motor 50 in each of the clamping process, the penetrating process, the clinching process, and the returning process from the current sensor 78, and writes (stores) the current value in the storage unit 80.

In addition, the second control unit 70 can measure operation time of each process with a timer (state detection unit) 70a and store the operation time of each process. Further, the second control unit 70 may calculate a difference (deviation) between target power or current value of the motor 50 and actually detected power or current value of the motor 50 for each process (in this case, the second control unit 70 may include a state detection unit that calculates the difference), and store a value of the difference in the storage unit 80.

The second control unit 70 includes a determination unit (abnormality determination unit) 70c that determines presence or absence of an abnormality for each process based on the detected or calculated current value, operation time, deviation, and the like. In addition, the second control unit 70 includes a counting unit 70b and an abnormality occurrence rate calculation unit 70d. The counting unit 70b can count the number of times of execution of the binding processing (for example, 100 times in a case where 100 paper bundles are bound), the number of errors indicating the number of times of abnormality for each process among a total number of times of execution, and the like, and the abnormality occurrence rate calculation unit 70d can calculate an error occurrence frequency (abnormality occurrence rate) for each process.

The motor driving unit 72 includes, for example, an inverter circuit having a plurality of switching elements (FET, IGBT, and the like), performs an ON and OFF switching operation based on a driving signal from the second control unit 70, converts DC power supplied from a DC power supply (not illustrated) into power having a predetermined duty ratio, and supplies the power to the motor 50.

The motor 50 is configured with, for example, a brushless motor, and rotates at a predetermined speed based on the power from the motor driving unit 72 to drive the penetration part 22, the clinch part 31, and the like via the gear 51.

The home position sensor 76 is a sensor for detecting whether a rotational position of the gear 51 is at a home position (initial position) corresponding to a start position for the binding processing. A signal from the home position sensor 76 is supplied to the second control unit 70. Therefore, when the gear 51 starts to rotate from the home position, the binding processing is started, and when the gear 51 rotates once and returns to the home position again, one time of binding processing is completed.

The storage unit 80 includes, for example, a hard disk drive (HDD), a solid state drive (SSD), or a semiconductor memory, and stores programs, various types of data, and the like. The storage unit 80 stores the current value of the motor 50 for each process (transition of the current value in the process, or the like). When the operation time of each process is measured, or the difference between the target power or current value of the motor 50 and the actually detected power or current value in each process is calculated, the data is also stored in the storage unit 80.

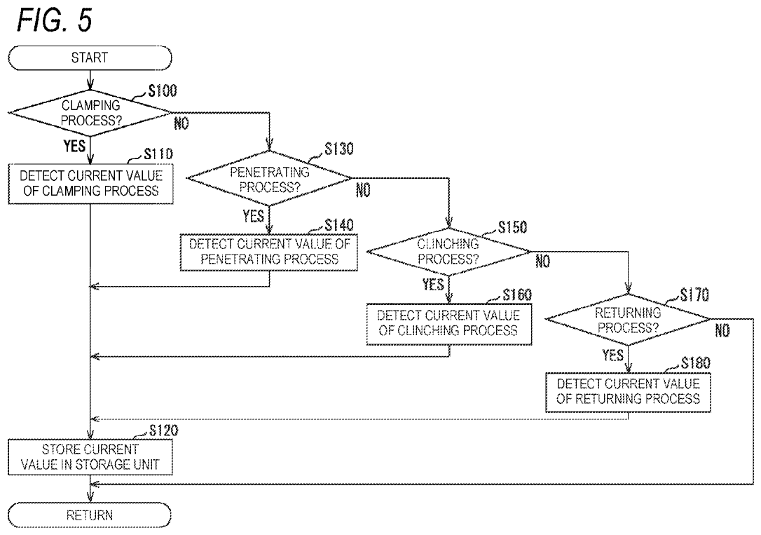

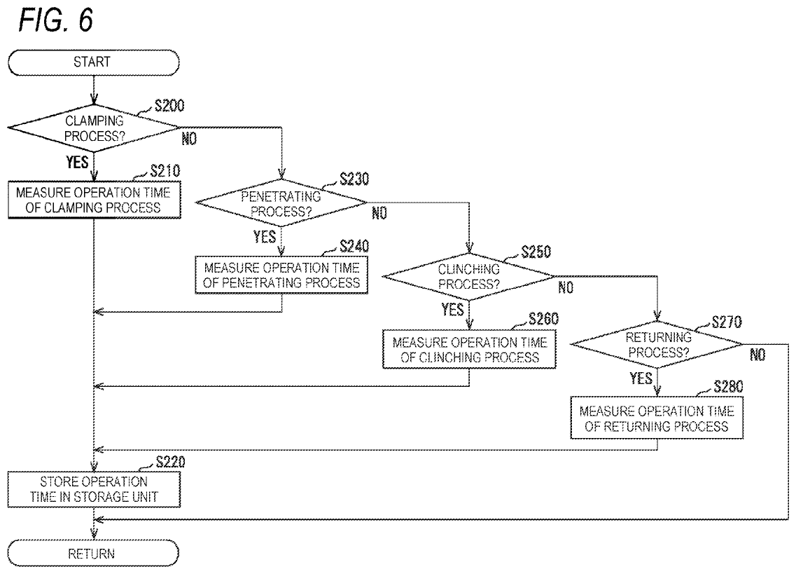

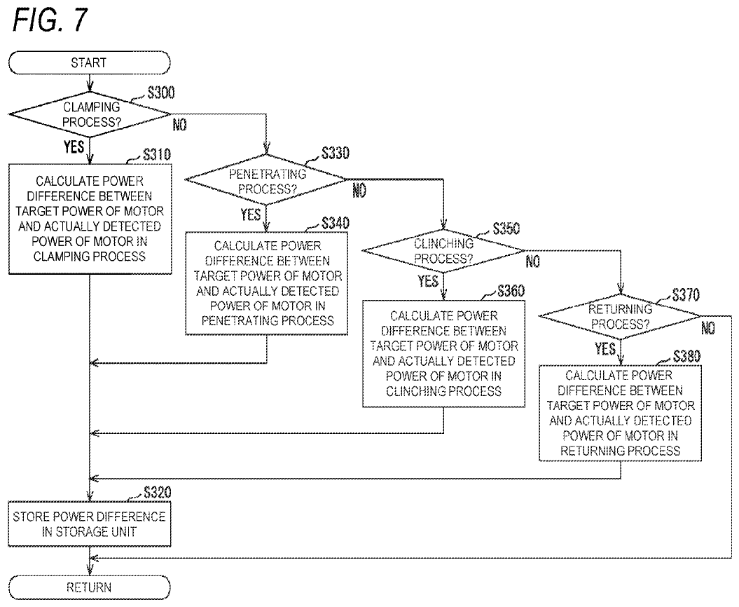

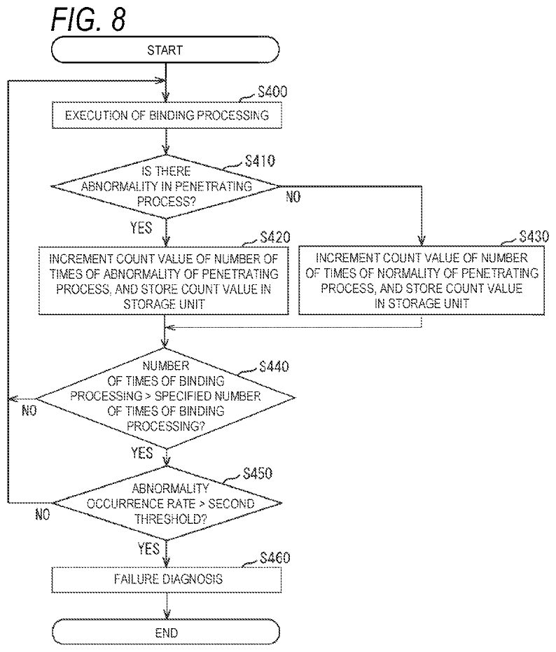

FIGS. 5 to 7 are flowcharts illustrating a flow of processing of the second control unit. FIG. 5 is a flowchart illustrating a flow of processing related to acquisition and storage of a current value of the motor 50 in each process. FIG. 6 is a flowchart illustrating a flow of processing related to measurement of the operation time of each process and storage of the measured operation time. FIG. 7 is a flowchart illustrating a flow of processing of calculating and storing a difference (deviation) between target power or current value of the motor and actually detected power or current value in each process. FIG. 8 is a flowchart in a case where abnormality diagnosis of the penetrating process is performed based on a current value stored in the storage unit 80.

When a binding command of the electric stapler 1 is received from the image forming system 100, the second control unit 70 drives the motor 50 to rotate the gear 51. Accordingly, the binding processing is started.

<Acquisition of Current Value of Motor 50 in Each Process (First Control Example)>

As illustrated in FIG. 5, it is determined in step S100 whether a current process is the clamping process, and when it is determined that the current process is the clamping process, the process proceeds to step S110 in which a current value of the motor 50 (in the clamping process) is acquired. Next, in step S120, the acquired current value is stored in the storage unit 80. The determination as to whether a current process is the clamping process, or the penetrating process, the clinching process, or the returning process, which will be described later, is made by detecting the rotational position of the gear 51 (rotation amount of the motor 50).

In step S100, when it is determined that the current process is not the clamping process, the process proceeds to step S130 in which it is determined whether the current process is the penetrating process. When it is determined in step S130 that the current process is the penetrating process, the process proceeds to step S140 in which the current value of the motor 50 (in the penetrating process) is acquired, and the acquired current value is stored in step S120.

When it is determined in step S130 that the current process is not the penetrating process, the process proceeds to step S150 in which it is determined whether the current process is the clinching process. When it is determined in step S150 that the current process is the clinching process, the process proceeds to step S160 in which the current value of the motor 50 (in the clinching process) is acquired, and the acquired current value is stored in step S120.

When it is determined in step S150 that the current process is not the clinching process, the process proceeds to step S170 in which it is determined whether the current process is the returning process. When it is determined in step S170 that the current process is the returning process, the process proceeds to step S180 in which the current value of the motor 50 (in the returning process) is acquired, and the acquired current value is stored in step S120. On the other hand, when it is determined in step S170 that the current process is not the returning process, the processing of this loop is ended.

<Measurement of Operation Time of Each Process (Second Control Example)>

As illustrated in FIG. 6, in step S200, it is determined whether the current process is the clamping process, and when it is determined that the current process is the clamping process, the process proceeds to step S210 in which the timer 70a measures the operation time of the clamping process. Next, in step S220, the measured operation time of the clamping process is stored in the storage unit 80. The determination as to whether a current process is the clamping process, or the penetrating process, the clinching process, or the returning process, which will be described later, is made by detecting the rotational position of the gear 51 (rotation amount of the motor 50).

In step S200, when it is determined that the current process is not the clamping process, the process proceeds to step S230 in which it is determined whether the current process is the penetrating process. When it is determined in step S230 that the current process is the penetrating process, the process proceeds to step S240 in which the timer 70a measures the operation time of the penetrating process, and the acquired operation time of the penetrating process is stored in step S220.

When it is determined in step S230 that the current process is not the penetrating process, the process proceeds to step S250 in which it is determined whether the current process is the clinching process. When it is determined in step S250 that the current process is the clinching process, the process proceeds to step S260 in which the operation time of the clinching process is measured, and the measured operation time of the clinching process is stored in step S220.

When it is determined in step S250 that the current process is not the clinching process, the process proceeds to step S270 in which it is determined whether the current process is the returning process. When it is determined in step S270 that the current process is the returning process, the process proceeds to step S280 in which the timer 70a measures the operation time of the returning process, and the measured operation time of the returning process is stored in step S220. On the other hand, when it is determined in step S270 that the current process is not the returning process, the processing of this loop is ended.

<Calculation of Difference Between Target Power or Target Current Value of Motor 50 and Actually Detected Power or Current Value of Motor 50 in Each Process (Third Control Example)>

As illustrated in FIG. 7, in step S300, it is determined whether the current process is the clamping process, and when it is determined that the current process is the clamping process, the process proceeds to step S310 in which a power difference between target power of the motor 50 and actually detected power of the motor 50 during the clamping process is calculated. Next, in step S320, the calculated power difference is stored in the storage unit 80. The determination as to whether a current process is the clamping process, or the penetrating process, the clinching process, or the returning process, which will be described later, is made by detecting the rotational position of the gear 51 (rotation amount of the motor 50). The target power corresponds to power of the motor 50 in a case where each process is normally operated, and is set in advance.

In step S300, when it is determined that the current process is not the clamping process, the process proceeds to step S330 in which it is determined whether the current process is the penetrating process. When it is determined in step S330 that the current process is the penetrating process, the process proceeds to step S340 in which a power difference between target power of the motor 50 and actually detected power of the motor 50 during the penetrating process is calculated, and the calculated power difference is stored in step S320.

When it is determined in step S330 that the current process is not the penetrating process, the process proceeds to step S350 in which it is determined whether the current process is the clinching process. When it is determined in step S350 that the current process is the clinching process, the process proceeds to step S360 in which a power difference between target power of the motor 50 and actually detected power of the motor 50 during the clinching process is calculated, and the calculated power difference is stored in step S320.

When it is determined in step S350 that the current process is not the clinching process, the process proceeds to step S370 in which it is determined whether the current process is the returning process. When it is determined in step S370 that the current process is the returning process, the process proceeds to step S380 in which a power difference between target power of the motor 50 and actually detected power of the motor 50 during the returning process is calculated, and the calculated power difference is stored in step S320. On the other hand, when it is determined in step S370 that the current process is not the returning process, the processing of this loop is ended.

<Failure Diagnosis (Fourth Control)>

The second control unit 70 executes abnormality diagnosis for each process of the binding processing by using various type of data stored in the storage unit 80 by executing the first control to the third control. In the following description, abnormality diagnosis of the penetrating process is illustrated as an example with reference to FIG. 8. In the clamping process, the clinching process, and the returning process, the same abnormality diagnosis processing is performed as in the penetrating process.

As illustrated in FIG. 8, when the binding processing is completed in step S400, in step S410, the current value of the penetrating process is read from the storage unit 80, and the determination unit 70c determines whether the read current value indicates an abnormal value. For example, a stored (actually detected) current value is compared with a preset first threshold, and when the stored current value exceeds (or falls below) the first threshold, it is determined that there is an abnormality. As an example of the abnormality, in a case where the current value indicates a larger value exceeding the first threshold, mechanical wear or biting of a foreign matter, an abnormality (failure or the like) of the motor 50, and the staple 10 being unable to penetrate the paper bundle are assumed. On the other hand, when the current value indicates a smaller value, buckling or blank shot of the staple 10, or the like is assumed.

In step S410, in a case where, as a result of determination of presence or absence of abnormality by the determination unit 70c, it is determined that the penetrating process is abnormal, a count value of the number of times of abnormality is incremented (increased by one) in step S420, and the count value is stored in the storage unit 80. On the other hand, when it is determined in step S410 that the penetrating process is normal, a count value of the number of times of normality is incremented in step S430, and the count value is stored in the storage unit 80.

In step S440, when the number of times of the binding processing is equal to or less than a predetermined specified number of times of the binding processing, the process returns to step S400 to continue the binding processing, and when the number of times of the binding processing exceeds the specified number of times of the binding processing, the process proceeds to step S450. In step S450, an abnormality occurrence rate of the penetrating process is calculated by the abnormality occurrence rate calculation unit 70d, and whether the calculated abnormality occurrence rate exceeds a predetermined second threshold is determined. The second threshold is set in consideration of, for example, operation guarantee in the binding processing, and is set with reference to, for example, history data that indicates a failure is likely to occur when an occurrence frequency of abnormality exceeds a predetermined value (for example, the predetermined value in this case is the second threshold). The abnormality occurrence rate is calculated by “the number of times of abnormality (the number of times of abnormal operations)/the number of times of binding processing (the total number of times of operations of the binding processing)”.

In step S450, when the abnormality occurrence rate in the penetrating process is equal to or less than the second threshold, the process returns to step S400 to continue the binding processing, and when it is determined that the abnormality occurrence rate exceeds the second threshold, the process proceeds to step S460 to perform failure diagnosis of the penetrating process. Specifically, since the abnormality occurrence rate exceeds the second threshold and the abnormality occurrence frequency is high, it is diagnosed that there is a high possibility that the penetration part 22 will fail in the future or there is a high possibility that the penetration part 22 is in a failed state. When it is diagnosed that there is a high possibility of a failure, for example, a message indicating the diagnosis result or a message prompting replacement, repair, or the like of a component may be displayed on a screen of the operation panel 210 provided in the image forming system 100. As another notification method, for example, an alarm lamp may be turned on, an alarm buzzer may be sounded, or a message prompting replacement, repair, or the like of a component may be displayed on an information processing device possessed by a serviceman and a user.

Although the abnormality diagnosis (abnormality determination, failure diagnosis) is performed based on the current value of the motor 50 in the example of FIG. 8, it is needless to say that the abnormality diagnosis may be performed based on the operation time of the penetrating process, and the difference (deviation) between the detected power or current value and the target power or current value. Alternatively, instead of performing the abnormality diagnosis using data of one of the current value, the operation time, and the difference (deviation), data of all or two of the current value, the operation time, and the difference (deviation) may be detected and stored, and be used to perform the abnormality diagnosis.

In addition, a change rate of the current value may be calculated, and the abnormality diagnosis may be performed based on the change rate instead of whether the current value of the motor 50 exceeds the first threshold. Specifically, when a large change rate is generated by comparing a current value of the motor 50 in the penetrating process of n-th binding processing with a current value of the motor 50 in the penetrating process of (n+1)-th binding processing is large, it is determined that an abnormality occurs. When the change rate of the current value is larger than a predetermined threshold (reference change rate), a failure diagnosis is performed to determine that wear or the like of a component (a driver or the like) used in the penetrating process occurs, and that there is a high possibility of failure in the future or there is a high possibility of failure in the current stage.

Although the abnormality diagnosis of the penetrating process is exemplified in FIG. 8, similar processing is performed for the abnormality diagnosis of the clamping process and the clinching process. For example, in the clinching process, in a case where the current value indicates a larger value, mechanical wear, biting of a foreign matter, an abnormality of the motor 50, and the like are assumed in substantially the same manner as in the penetrating process, and in a case where the current value is smaller, blank shot (for example, the staple 10 does not penetrate the paper bundle), striking and missing (for example, positional deviation between a clincher and the staple 10 in the clinch part 31), and the like are assumed.

In the fourth control, each time a process of the binding processing is completed, the presence or absence of an abnormality in the process is determined, but the present invention is not limited thereto. For example, after a series of processes (one time) of the binding processing is completed, the presence or absence of an abnormality may be determined for each process based on the data stored in the storage unit 80. Alternatively, after the binding processing is performed a predetermined number of times, the presence or absence of an abnormality in each process for the predetermined number of times of binding processing may be collectively determined. Of course, after all the number of times of binding processing are completed, that is, after all the binding operations of the electric stapler 1 are completed, the presence or absence of an abnormality may be determined based on the data stored in the storage unit 80.

In the fourth control, it may be determined whether an abnormality occurs in the entire binding processing instead of in each process of the binding processing. Specifically, reference operation time of one time of the binding processing in a case where the binding process is normally completed may be set based on the number of pulses or a driving shaft angle of the motor 50 detected by a Hall sensor of the motor 50, actually measured operation time of one time of binding processing may be compared with the reference operation time, and it may be determined that the binding processing is abnormal when actual operation time of the binding processing exceeds the reference operation time. In this way, the abnormality diagnosis may be performed.

According to the present embodiment, since it is possible to detect a state such as a current value of the motor 50, operation time for each process, a difference between target power or target current value of the motor 50 and actually detected power or current value of the motor 50 in each process, and the like for each process of the binding processing, it is possible to determine, for example, in which process an operation failure occurs. In addition, by storing the current value of the motor 50 and the like for each process in the storage unit 80, when a cause of the failure of the electric stapler 1 is to be investigated later, the investigation can be easily performed based on information on the current value of the motor 50 or the like stored in the storage unit 80. Accordingly, it is possible to improve the efficiency of malfunction analysis and shorten the time of malfunction analysis of the electric stapler 1. In addition, since service measures such as replacement or repair of the electric stapler 1 can be performed in advance before a failure or the like of the electric stapler 1 occurs, it is possible to improve convenience for a user.

Further, according to the present embodiment, since life of the electric stapler 1 can be predicted and determined based on the number of abnormal operations (errors) stored in the storage unit 80 of the electric stapler 1, a state of the electric stapler 1 can be quickly determined when reusing the electric stapler 1.

Further, according to the present embodiment, since it is possible to predict a failure of the electric stapler 1 based on the number of times of abnormal operations or the abnormality occurrence rate stored in the storage unit 80 of the electric stapler 1, it is possible to quickly determine the state of the electric stapler 1 when reusing the electric stapler 1, and it is possible to perform replacement or repair on the electric stapler 1 before the electric stapler 1 fails. Accordingly, it is possible to shorten a period (downtime) in which a user cannot use a stapling function.

Although the preferred embodiments of the present disclosure have been described in detail with reference to the accompanying drawings, the technical scope of the present disclosure is not limited to these examples. It will be apparent that a person having ordinary knowledge in the technical field of the present disclosure can conceive of various changes or modifications within the scope of the technical idea described in the claims, and it is understood that the various changes or modifications naturally belong to the technical scope of the present disclosure.

For example, in the first to fourth control described above, information such as the rotation amount of the gear 51 at the time of occurrence of abnormality, for example, information indicating a stop position of the gear 51 for each process at the time of locking may be calculated based on the number of pulses or the driving shaft angle of the motor 50 detected by the Hall sensor of the motor 50, and then stored in the storage unit 80. In this case, for example, when it is determined that locking occurs in the penetrating process by referring to the information indicating the stop position of the gear 51 stored in the storage unit 80, since a possibility of an abnormality on the paper side is also considered, initialization processing by a reverse rotation operation of the motor 50 may be executed to determine that binding processing can be performed again, without immediately diagnosing a failure. In addition, when the information indicating the stop position of the gear 51 stored in the storage unit 80 is referred to and it is determined that locking occurs in a position where locking cannot be normally caused, for example, in a returning process or a clamping process, a failure may be immediately diagnosed, and a service call may be transmitted to an information processing device of a serviceman or the like. Further, according to the information of the stop position of the gear 51, it may be determined whether the initialization processing by the reverse rotation operation of the motor 50 is performed by forward rotation or by reverse rotation.

In addition, machine-specific information of the electric stapler 1 determined to have an abnormality and malfunction occurrence information indicating specific contents of the abnormality occurring in the electric stapler 1 may be stored in the storage unit 80 in association with each other. In addition, in the electric stapler 1, version upgrade of software including update of the first threshold and the second threshold may be performed in consideration of a result of the failure diagnosis and the like.

In addition, although an example in which the electric stapler 1 is incorporated in the post-processing device 300 is described in the above-described embodiment, the present invention is not limited thereto. Alternatively, the electric stapler 1 including the storage unit 80 of the present disclosure may be incorporated in, for example, the image forming device 200 illustrated in FIG. 1.

### REFERENCE SIGNS LIST

1 stapler
4 clamp part
5 driving unit
22 penetration part
31 clinch part
50 motor (driving unit)
51 gear (driving unit)
70 second control unit (state detection unit, abnormality determination unit, abnormality occurrence rate calculation unit)
70a timer (state detection unit)
70b counting unit
70c determination unit (abnormality determination unit)
70d abnormality occurrence rate calculation unit
78 current sensor (state detection unit)
80 storage unit

What is claimed is:

1. An electric stapler including a clamp part that clamps a paper bundle, a penetration part that causes a staple to penetrate the paper bundle, a clinch part that bends the staple penetrating the paper bundle to bind the paper bundle, a driving unit that drives the clamp part, the penetration part, and the clinch part, and performing binding processing by at least performing a clamping process of clamping the paper bundle with the clamp part, a penetrating process of causing the staple to penetrate the paper bundle with the penetration part, and a clinching process of bending the staple penetrating the paper bundle with the clinch part, the electric stapler comprising:
a state detection unit that detects a state of the driving unit in each of the clamping process, the penetrating process and the clinching process; and
a storage unit that stores the detected state.

2. The electric stapler according to claim 1,
wherein a state of the driving unit to be detected by the state detection unit is a driving current of the driving unit in each of the clamping process, the penetrating process and the clinching process.

3. The electric stapler according to claim 1,
wherein a state of the driving unit to be detected by the state detection unit is driving time of the driving unit in each of the clamping process, the penetrating process and the clinching process.

4. The electric stapler according to claim 1,
wherein the state of the driving unit to be detected by the state detection unit is a difference between a target state of the driving unit and a detected state of the driving unit.

5. The electric stapler according to claim 1, further comprising:
an abnormality determination unit that determines a process, in which an abnormality occurs, based on a state of the driving unit.

6. The electric stapler according to claim 5,
wherein the abnormality determination unit determines presence or absence of an abnormality in the clamping process based on a state of the driving unit in the clamping process.

7. The electric stapler according to claim 5,
wherein the abnormality determination unit determines presence or absence of an abnormality in the penetrating process based on a state of the driving unit in the penetrating process.

8. The electric stapler according to claim 5,
wherein the abnormality determination unit determines presence or absence of an abnormality in the clinching process based on a state of the driving unit in the clinching process.

9. The electric stapler according to claim 5, further comprising:
a counting unit that counts a number of abnormality for each process every time the binding processing is performed,
wherein the storage unit stores the counted number of abnormality for each process.

10. The electric stapler according to claim 9,
wherein the counting unit counts a number of normality for each process every time the binding processing is performed, and
wherein the storage unit stores the counted number of normality for each process.

11. The electric stapler according to claim 10, further comprising:
an abnormality occurrence rate calculation unit that calculates an abnormality occurrence rate for each process based on the counted number of abnormality and the counted number of normality,
wherein the storage unit stores the abnormality occurrence rate.

12. An image forming device comprising the electric stapler according to claim 1.

13. A post-processing device comprising the electric stapler according to claim 1.

14. An electric stapler including a clamp part that clamps a paper bundle, a penetration part that causes a staple to penetrate the paper bundle, a clinch part that bends the staple penetrating the paper bundle to bind the paper bundle, a motor that drives the clamp part, the penetration part, and the clinch part, and performing binding processing by at least performing a clamping process of clamping the paper bundle with the clamp part, a penetrating process of causing the staple to penetrate the paper bundle with the penetration part, and a clinching process of bending the staple penetrating the paper bundle with the clinch part, the electric stapler comprising:
a controller that detects a state of the motor in each of the clamping process, the penetrating process and the clinching process; and
a storage unit that stores the detected state, the storage unit including at least one of memory and a drive.
